(19) United States
(12) Patent Application Publication
(10) Pub. No.: US 2008/0169226 A1
(43) Pub. Date: Jul. 17, 2008

(54) Apparatus and Method to Separate Particles of Very Fine Granulometry From an Incoherent Mass of Woody Material

(75) Inventor: Antonio Dal Ben, S. Biagio di C. Ta (IT)

Correspondence Address: STEVENS DAVIS LLP, 1615 L STREET NW, SUITE 850, WASHINGTON, DC, 20036, US

(73) Assignee: PAL SRL, Ponte di Piave (TV) (IT)

(21) Appl. No.: 11/911,519

(22) PCT Filed: Apr. 13, 2006
(86) PCT No.: PCT/EP06/61574

§ 371 Date: Oct. 12, 2007

(30) Foreign Application Priority Data
Apr. 18, 2005 (IT) UD2005A000063

(51) Int. Cl. B07B 13/04

(52) U.S. Cl. 209/659

(57) ABSTRACT

An apparatus and a method to separate particles having a first granulometry, between some hundredths of a millimeter and about 6 tenths of a millimeter, from an incoherent mass of woody material consisting of particles of wood and contaminants, having a second granulometry between some hundredths of a millimeter and about 10 mm. The apparatus has fixed screening elements, substantially tubular in shape, inside which rotary members are mounted rotatable, which impart to the mass a determinate centrifugal force. The fixed screening elements are provided with a plurality of through apertures through which the particles having the first granulometry pass. The apparatus also has command members which impart to the rotary members a determinate peripheral velocity such as to apply to each unitary quantity of mass a centrifugal force sufficient to expel the contaminants having the first granulometry through the through apertures.

### FIELD OF THE INVENTION

The present invention concerns an apparatus and a method to separate the particles and granules of contaminants, consisting of silica, stones, other minerals, metals, plastic, glass or other, of “very fine” granulometry, that is, comprised between some hundredths of a millimeter and about 6 tenths of a millimeter, from an incoherent mass of woody material, fresh or recycled, damp or dry. The incoherent mass usually consists of particles of wood and contaminants, both having a granulometry comprised between some hundredths of a millimeter and about 10 mm. The elimination of the contaminants from the woody material is intended for the use, advantageously, of the remaining particles of wood for the subsequent production of wood-based panels, for example of chipboard, MDF (Medium Density Fibreboard), OSB (Oriented Structural Boards or Oriented Strands Boards), and other types.

### BACKGROUND OF THE INVENTION

It is known that, in order to separate or screen elements and/or materials of different granulometry, especially those of vegetable origin, such as the fragments or particles of wood or suchlike, mechanical and/or pneumatic devices are used, which roughly separate the wood from the other materials, the so-called contaminants, present in the incoherent mass.

Heavy contaminants, consisting mainly of silica, stones, other minerals, metals, hard plastics and glass, of larger granulometry, for example more than that accepted by a screen with a square mesh sieve from 1 mm×1 mm or above, can usually be removed, with good efficiency, from the particles of wood using known devices, such as pneumatic selectors, densimetric or gravimetric separators.

On the contrary, the so-called “fine” heavy contaminants, that is, those with a granulometry comprised between about 0.6 mm and about 1.5 mm, and the so-called “very fine” contaminants, that is, those with a granulometry comprised between some hundredths of a millimeter and about 6 tenths of a millimeter, are difficult to remove, or can be removed with a very low efficiency, by means of the above mentioned known devices, especially when the incoherent mass is damp. In the state of the art, particular difficulty is encountered in removing very fine contaminants.

In the production of chipboard panels, MDF and OSB, the excess of residual heavy contaminants in the particles of wood causes excessive wear in the plants in the area where the wood particles are prepared, poor workability of the panels themselves, with consequent greater consumption of cutting tools and abrasive belts used for smoothing.

Moreover, in the production of MDF panels, the excess of heavy contaminants increases the pollution of the water used for washing the chips and the premature wear of the segments of refiners or grinders.

To overcome these problems, in the state of the art it is necessary to remove from the incoherent mass the particles, including the wood particles, of fine or very fine granulometry, that is, comprised from some hundredths of a millimeter to about 1.5 mm, which are then entirely destined for combustion, with a consequent excessive waste of woody material.

One purpose of the present invention is to achieve an apparatus, and perfect a relative method, which allow to separate, from the particles of wood, the very fine contaminants, that is, those with a granulometry comprised between some hundredths of a millimeter and about 6 tenths of a millimeter.

The Applicant has devised, tested and embodied the present invention to overcome the shortcomings of the state of the art and to obtain these and other purposes and advantages.

### SUMMARY OF THE INVENTION

The present invention is set forth and characterized in the main claims, while the dependent claims describe other characteristics of the invention or variants to the main inventive idea.

In accordance with the above purpose, an apparatus according to the present invention is able to separate the very fine particles of contaminants, consisting of silica, stones, other minerals, metals, plastic, glass or other, of very fine granulometry as defined above, from an incoherent mass of woody material, fresh or recycled, damp or dry, consisting of particles of wood and contaminants, having a granulometry comprised between some hundredths of a millimeter and about 10 mm.

The apparatus according to the invention comprises fixed screening means, substantially tubular in shape, inside which a rotor is mounted rotatable and able to impart to said mass a determinate centrifugal force (Fc). Moreover, said fixed screening means are provided with a plurality of through apertures able to allow the passage towards the outside of said very fine contaminants, the larger particles being discharged through a different aperture.

According to a characteristic feature of the present invention the outer diameter of said rotor, which is a little less than that of the fixed screening means, is comprised between about 400 mm and about 1,000 mm, advantageously about 500 mm.

According to another characteristic feature of the present invention, command means are able to impart to said rotor a determinate peripheral velocity (Vp), such as to apply to each unitary value or unitary quantity of said mass a centrifugal force (FC) sufficient to expel said very fine contaminants through said through apertures.

For each kilogram of incoherent mass, said centrifugal force (Fc) is advantageously comprised between about 500 N and about 2,500 N, preferably between about 1,600 N and about 1,700 N.

Applicant has in fact found that, by applying said centrifugal force to said unitary quantity of the incoherent mass, said mass is thrust towards the fixed screening means with a centrifugal acceleration comprised between about 500 m/sec² and about 2,500 m/sec², advantageously between about 1,600 m/sec² and about 1,700 m/sec², with a consequent separation therefrom of the very fine particles, including the very fine heavy contaminants. The latter therefore exit from the through apertures of the fixed screening means, which advantageously consist of circular holes having a diameter comprised between about 0.5 mm and about 2.5 mm.

The separation of both the contaminants and the particles of wood of very fine granulometry from the elements of larger size introduced into the apparatus according to the present invention, occurs substantially in the same way.

Therefore, the mass of woody material, at the end of the screening process, irrespective of the sizes of the initial elements of which it is consists, is substantially without very fine contaminants.

In this way, the wood-based panels made with the particles processed by the apparatus according to the present invention have a percentage of very fine contaminants within the limits laid down by the prevailing legislation, that is, less than 0.05%.

Upstream and/or downstream of the apparatus according to the present invention further apparatuses of a known type can be provided, either pneumatic, or vibratory, or rotational, able to effect the screening of the mass of woody material, in order to divide it into groups consisting of elements of different sizes ad/or to effect other types of separation.

The sizes of the through apertures provided on the fixed screening means, and the sizes of the rotor, are defined according to the sizes and types of the particles that are introduced into the apparatus according to the present invention.

The different sizes of the apparatus, especially those of the rotary means, consequently entail the need to adapt the speed of rotation thereof, so that the centrifugal force imparted to the unitary mass remains comprised between said characteristic values.

Applicant has also found that the present invention provides particularly satisfactory results when the peripheral velocity of the rotor is comprised, respectively, between about 16 m/s and about 38 m/s, advantageously between about 18 m/s and about 25 m/s.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a lateral schematic view of the apparatus according to the present invention, applied in a plant for the separation of a mass of woody material;

FIG. 2 is a lateral view of the apparatus in FIG. 1;

FIG. 3 is an enlarged view of the detail III of the apparatus in FIG. 1.

### DETAILED DESCRIPTION OF A PREFERENTIAL FORM OF EMBODIMENT

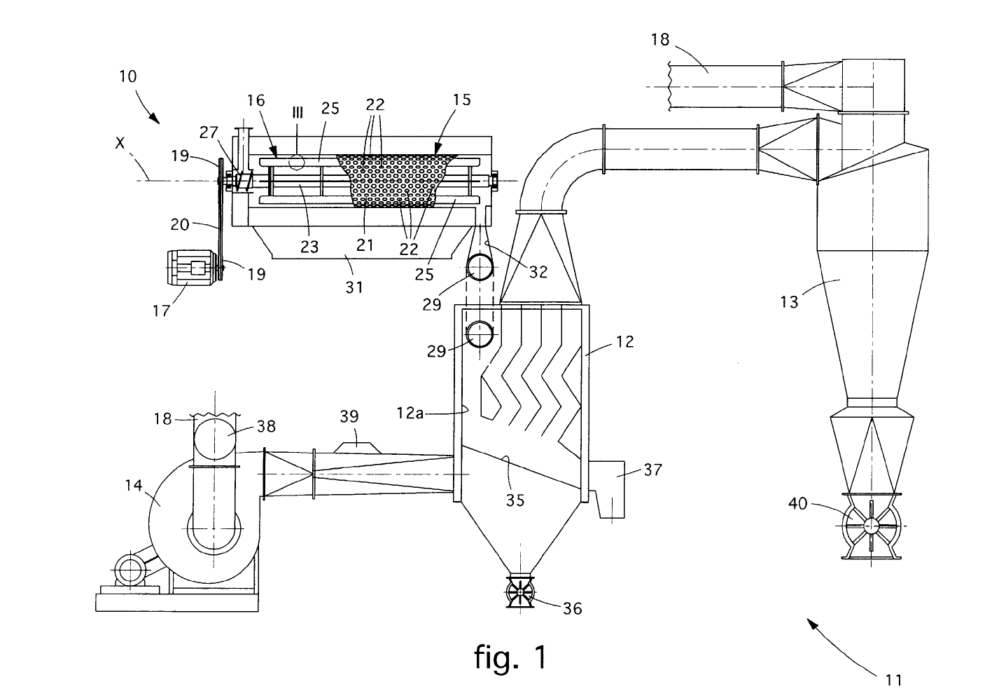

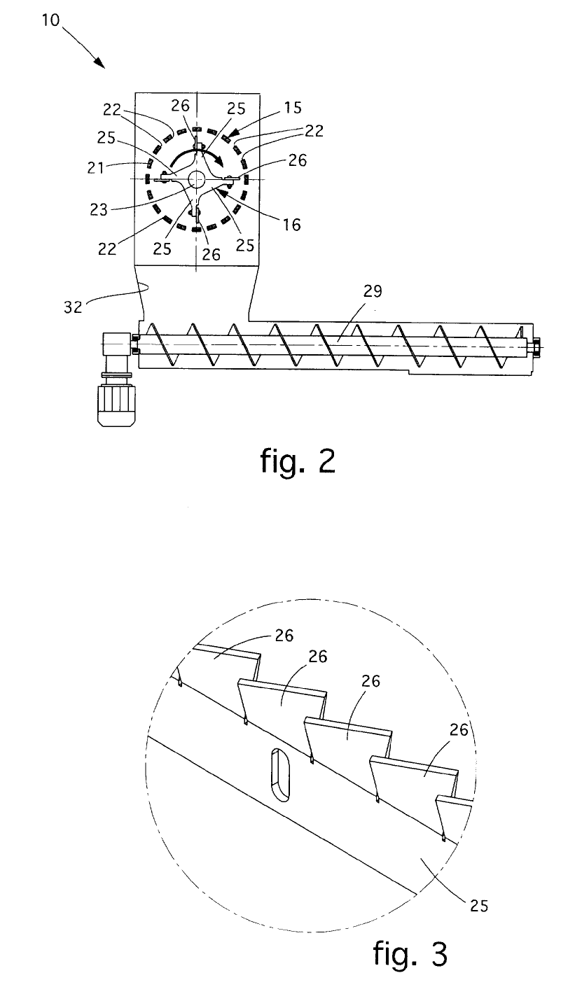

With reference to FIGS. 1, 2 and 3, an apparatus 10 according to the present invention in this case is installed in a plant 11 to divide an incoherent mass of woody material, including contaminants, into particles of decontaminated wood on the one side, and contaminants and working off-casts on the other side.

The apparatus 10 is able to be fed from above, in a known manner, with an incoherent mass of woody material consisting of particles, wood and contaminants, with a granulometry comprised between some hundredths of a millimeter and about 10 mm, and to separate from this mass the very fine particles, as defined above.

To be more exact, the apparatus 10 consists essentially of a centrifugal screen which comprises a fixed screening drum 15, substantially cylindrical in shape and having a longitudinal median axis X. Inside the screening drum 15 a rotor 16 is mounted coaxially rotatable, and is able to apply a determinate centrifugal force Fc to each unitary quantity, for example a kilogram, of the mass of woody material. In this case, the centrifugal force Fc is advantageously equal to about 1,600N.

The apparatus 10 also comprises an electric motor 17 connected to the rotor 16 by means of a pair of pulleys 19 connected to each other by a transmission belt 20. The number of revolutions of the electric motor 17 and/or the transmission ratio between the pulleys 19 is chosen according to the size of the rotor 16, so as to apply in any case said centrifugal force Fc to the mass of woody material.

The screening drum 15 comprises a cylindrical wall 21 provided with a plurality of circular through holes 22, in this case having a diameter of about 1.5 mm.

Through the holes 22 the very fine particles separated from the rest of the mass of woody material are able to exit. The sizes of the through holes 22 are slightly greater with respect to the sizes of the very fine particles, so as to facilitate their exit from the screening drum 15.

The rotor 16 comprises a rotation shaft 23 on which a plurality of blades 25 are attached, in this case four, disposed angularly offset by 90° with respect to each other. Each blade 25 has at one outer end a plurality of fins 26 disposed inclined.

The outer diameter of the rotor 16 in this case is about 500 mm.

The rotation shaft 23 is keyed with one end to one of the two pulleys 19, so as to rotate therewith, and on at least one terminal end, disposed in correspondence with the feed zone, has one or more helical ridges 27 which form a small screw and thrust the woody mass axially towards the blades 25.

By means of the electric motor 17, the shaft 23 is made to rotate at about 770 rpm, in order to impart to the blades 25 a peripheral velocity Vp of about 20 m/s, so that the woody mass is subjected to the determinate centrifugal force Fc.

In this way, the mass introduced, including the very fine contaminants, is thrust towards the fixed screening drum 15 with a centrifugal acceleration such as to cause the very fine contaminants to become detached and to exit from the holes 22 of the screening drum 15 and, through the exit 31, from the apparatus 10.

During the violent process of centrifugation in the apparatus 10, the very fine granules of silica adhering to the damp particles of wood are thus also easily removed. The bigger particles, possibly containing pieces of silica or other materials, which have not passed through the holes 22, are conveyed towards the exit 32 instead.

The apparatus 10 also comprises, in correspondence with the exit 32, a feed screw 29 which transports the larger particles inside a separation device consisting for example of a pneumatic selector, of a known type. The plant 11 also comprises a ventilator 14 which, by means of a pipe 18, is able to suck in air from inside a cyclone 13, of a known type, and to introduce it into the fluidization chamber 12a of the pneumatic selector 12. The current of ascending air created by the depression inside the selector 12 causes the particles of wood, which are lighter, to rise, and the contaminants, which are heavier, to fall, with the subsequent expulsion of the latter through a holed metal sheet 35 and a star valve 36, or through the discharge mouth 37.

The selection limit of the selector 12 is adjustable, in a known manner, by varying the speed of the ascending air in the chamber 12a, by regulating an introduction valve 38 and an expulsion valve 39 of the “used” air, and by varying the speed of the ventilator 14, by means of an inverter of a known type.

The particles of wood thus decontaminated by a double cleaning system, consisting of the apparatus 10 and the selector 12, are discharged to the production process through the star valve 40 of the cyclone 13.

It is clear that instead of the pneumatic selector 12 described above, other types of pneumatic selectors may be used, or gravimetric and densimetric separators of a known type, to be coupled downstream of the apparatus 10.

It is clear, however, that modifications and/or additions of parts or steps may be made to the apparatus 10 and method as described heretofore, without departing from the scope of the present invention.

It is also clear that, although the present invention has been described with reference to specific examples, a person of skill in the art shall certainly be able to achieve many other equivalent forms of apparatus and method to separate particles of very fine granulometry form an incoherent mass of woody material, having the characteristics as set forth in the claims and hence all coming within the field of protection defined thereby.

1. An apparatus to separate particles having a first granulometry, comprised between some hundredths of a millimeter and about 6 tenths of a millimeter, from an incoherent mass of woody material consisting essentially of particles of wood and contaminants, having a second granulometry comprised between some hundredths of a millimeter and about 10 mm, said apparatus comprising:
fixed screening means, substantially tubular in shape, inside which rotary means are mounted rotatable, able to impart to said mass a determinate centrifugal force, and
wherein said fixed screening means are provided with a plurality of through apertures through which said particles having said first granulometry are able to pass,
wherein said rotary means comprise a rotor which is mounted rotatable coaxially with a longitudinal median axis of said fixed screening means, and has an outer diameter comprised between about 400 mm and about 1,000 mm, and
wherein command means is provided to impart to said rotor a determinate peripheral velocity such as to apply to each unitary quantity of said mass a centrifugal force sufficient to expel the contaminants having said first granulometry through said through apertures.

2. An apparatus as in claim 1, wherein, for each kilogram of said incoherent mass, said centrifugal force is comprised between about 500 N and about 2,500 N, in order to thrust said incoherent mass towards said fixed screening means with a centrifugal acceleration comprised between 500 m/sec² and about 2,500 m/sec².

3. An apparatus as in claim 2, wherein said determinate centrifugal force is comprised between about 1,600 N and about 1,700 N and said centrifugal acceleration is comprised between about 1,600 m/sec² and about 1,700 m/sec².

4. An apparatus as in claim 1, wherein said determinate peripheral velocity is comprised between about 16 m/s and about 38 m/s.

5. An apparatus as in claim 4, wherein said determinate peripheral velocity is about 20 m/s.

6. An apparatus as in claim 1, wherein said outer diameter is about 500 mm.

7. An apparatus as in claim 1 wherein said rotor comprises a rotation shaft on which a plurality of radial elements are fixed.

8. An apparatus as in claim 7, wherein said plurality of radial elements comprise four blades angularly offset by 90° with respect to each other.

9. An apparatus as in claim 8, wherein each of said blades is provided at one external end with a plurality of inclined fins.

10. An apparatus as in claim 7, wherein said rotation shaft has one or more helical elements able to induce said incoherent mass of woody material to move axially towards said radial elements.

11. An apparatus as in claim 1, wherein said command member comprises an electric motor connected to said rotor and able to impart to said rotor a determinate angular velocity, according to the outer diameter of said rotor, in order to obtain said determinate peripheral velocity.

12. An apparatus as in claim 1, wherein said through apertures have sizes comprised between about 0.5 mm and about 2.5 mm.

13. An apparatus as in claim 12, wherein said through apertures are circular holes with a diameter of about 1.5 mm.

14. An apparatus as in claim 1, wherein a transport member is provided downstream of said rotor to transport the largest particles of said incoherent mass towards a separation device.

15. A method to separate particles having a first granulometry, comprised between some hundredths of a millimeter and about 6 tenths of a millimeter, from an incoherent mass of woody material consisting essentially of particles of wood and contaminants, having a second granulometry comprised between some hundredths of a millimeter and about 10 mm, by means of a rotor inserted inside fixed screening means, substantially tubular in shape and provided with a plurality of through apertures, comprising:
rotating said rotor, having an outer diameter comprised between about 400 mm and about 1,000 mm, and mounted rotatable coaxially with a longitudinal median axis of said fixed screening means, at a determinate peripheral velocity, to apply to each unitary quantity of said incoherent mass a centrifugal force sufficient to expel the contaminants of very fine granulometry through said through apertures.

16. A method as in claim 15, wherein, for each kilogram of said incoherent mass, said centrifugal force is comprised between about 500 N and about 2,500 N, in order to thrust said mass towards said fixed screening means with a centrifugal acceleration comprised between 500 m/sec² and about 2,500 m/sec².

17. A method as in claim 16, wherein said determinate centrifugal force is comprised between about 1,600 N and about 1,700 N and said centrifugal acceleration is comprised between about 1,600 m/sec² and about 1,700 m/sec².

18. A method as in claim 15, wherein said determinate peripheral velocity is comprised between about 16 m/s and about 38 m/s.

19. A method as in claim 15, wherein said incoherent mass of woody material consists of particles of wood and contaminants.

20. An apparatus as in claim 1, wherein said incoherent mass of woody material consists of particles of wood and contaminants.
